(19) United States
(12) Patent Application Publication
(10) Pub. No.: US 2019/0057133 A1
(43) Pub. Date: Feb. 21, 2019

(54) SYSTEMS AND METHODS OF BOUNDED SCANS ON MULTI-COLUMN KEYS OF A DATABASE

(71) Applicant: salesforce.com, inc., San Francisco, CA (US)

(72) Inventors: Mikhail Chainani, San Francisco, CA (US); Ashwini Bijwe, San Francisco, CA (US)

(21) Appl. No.: 15/677,737

(22) Filed: Aug. 15, 2017

(51) Int. Cl. G06F 17/30

(52) U.S. Cl. CPC G06F 17/30507; G06F 17/30336; G06F 17/30315; G06F 17/30486

(57) ABSTRACT

Systems and methods perform a bounded scan on multi-column keys of a database system which stores data in a storage device. The systems and methods may include creating an index on one or more columns of a table of a database stored in the storage device. A first query for data in the indexed table may be received by the database system, where the query includes a scan range operation. The database system may translate the first query that includes the scan range operation into a plurality of sub-queries having respective scan ranges. A second query may be formed by combining the sub-queries with an operation. The systems and methods may process the second query and output a result of the second query.

### BACKGROUND

Certain types of applications need to create database tables with multi-column keys. System background jobs, such as tools for replication, migration, deletion, sweepers, and the like, may need to scan the entire table. Scanning the table, one tenant identifier at a time, requires a large number of queries with unpredictable size of results. Full table scans can be performed, but they typically take a long time to perform, and utilize a lot of database system resources. Indexes can be built on one or more columns of the table, where each column in the index is ordered and the sort order is specified when the index is created. However, present systems do not provide a query operator to perform bounded multi-column scans on tables or indexed tables.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1A shows an example method of performing a bounded scan on multi-column keys of a database system according to an implementation of the disclosed subject matter.

FIG. 1B shows an example of a record in a database system according to an implementation of the disclosed subject matter.

FIG. 2 shows an example of performing scans of a table, one identifier at a time, according to queries in traditional database systems.

FIG. 3 shows an example of performing a traditional full table scan of a database.

FIG. 4 shows an example of dividing a table using milestones according to traditional database systems.

FIG. 5 shows an example of dividing a table into a lower bound and an upper bound according to an implementation of the disclosed subject matter.

FIG. 6 shows an example of scanning an index starting at lower bound column values and ending at upper bound column values, and returning the resulting rows in the range according to an implementation of the disclosed subject matter.

FIG. 7 shows an example of scanning a table with a lower bound inclusive term, a lower bound term, an inner term, an upper bound term, and an upper bound inclusive term according to an implementation of the disclosed subject matter.

FIG. 8 shows a scan of a two column index table according to an implementation of the disclosed subject matter.

FIG. 9 shows an example system for storing and retrieving data from tables using a virtualization layer according to an implementation of the disclosed subject matter.

FIG. 10 shows a computer according to an implementation of the disclosed subject matter.

FIGS. 11A-11B show network configurations according to an implementation of the disclosed subject matter.

### DETAILED DESCRIPTION

Indexes for a database may be built on one or more columns of a database table. Each column in the index may be ordered, and the sort order may be determined when the index is created. The index may be maintained by operations (e.g., Data Manipulation Language (DML) operations, or other operations such as insert, update, delete, or the like) on the table.

When performing queries on the table, the index may be used to improve performance. Indexes may provide increased efficiency in row lookup operations, such as in a unique scan), and/or in performing simple scans, such as single column scans, scans of a particular range, or the like.

Implementations of the disclosed subject matter provide a scan range operator for a database query language that allows for data to be accessed using an indexed database. When used in a query, the database system may scan the index, starting at the lower bound column values and end at the upper bound column values, and return the resulting rows in that range. Implementations of the disclosed subject matter translate queries with the scan range operator to standard queries (e.g., SQL queries). That is, implementations of the disclosed subject matter break a query into multiple smaller index scans connected by, for example, a UNION ALL set operation.

The implementations of the disclosed subject matter provide advantages over present database systems and methods by reducing the complexity of a query, and allowing application developers to reduce their focus on the number and/or ordering of the one or more columns of a table in a database. Although system resources may be used in translating the query, the reduction of the complexity of the query more efficiently utilizes system resources, when compared to present systems.

Implementations of the disclosed subject matter can reduce the complexity of queries using standard operators by using a scan range operator. The complexity of the query may increase proportionally to the number of scan columns.

Implementations of the disclosed subject matter may return all the rows with column values between lower bound and upper bound. In some implementations, the lower bound and upper bound may be predefined. If upper bound column values are before lower bound values, then no rows are returned. If lower bound column values are NULL, all rows from the beginning (unbounded) of the index are returned. If upper bound column values are NULL, all rows until the end (unbounded) of the index are returned.

Implementations of the disclosed subject matter may be used for full table scans or partial table scans. The portion of the table scanned may be application dependent. For most applications, unless a full table scan is needed, the systems and methods of the disclosed subject matter may be used for partial table scans to minimize the use of system resources and increase system efficiency.

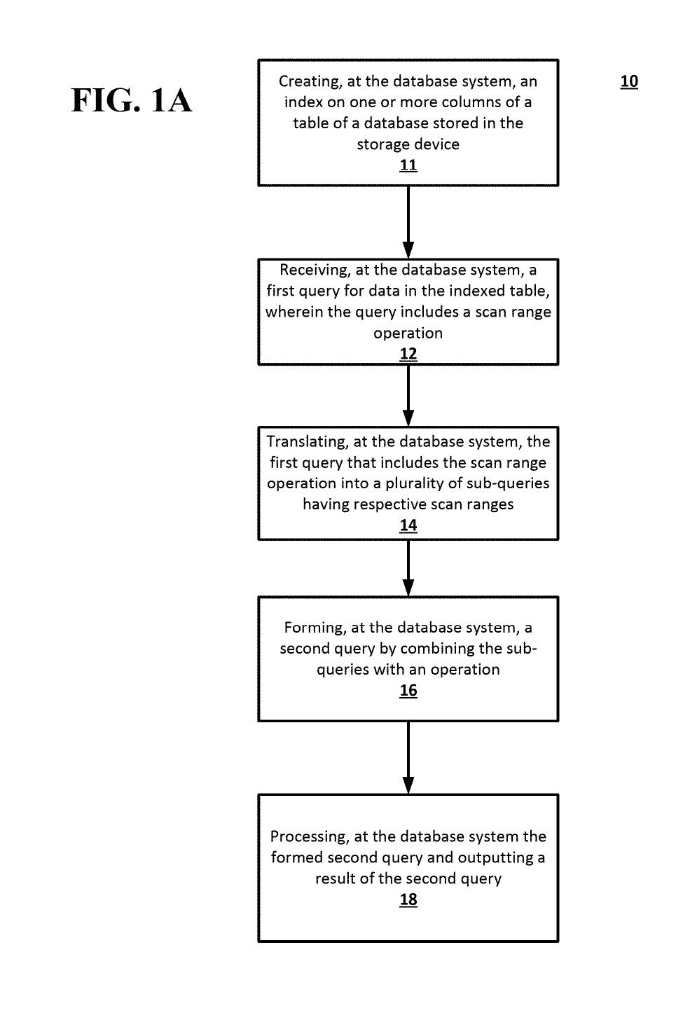

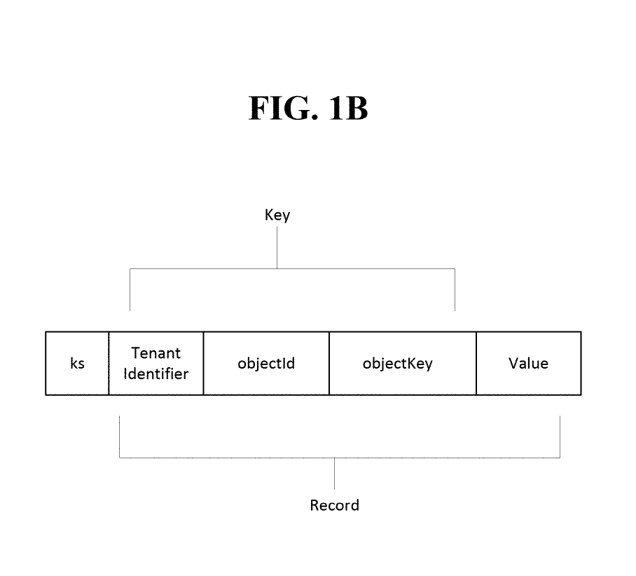

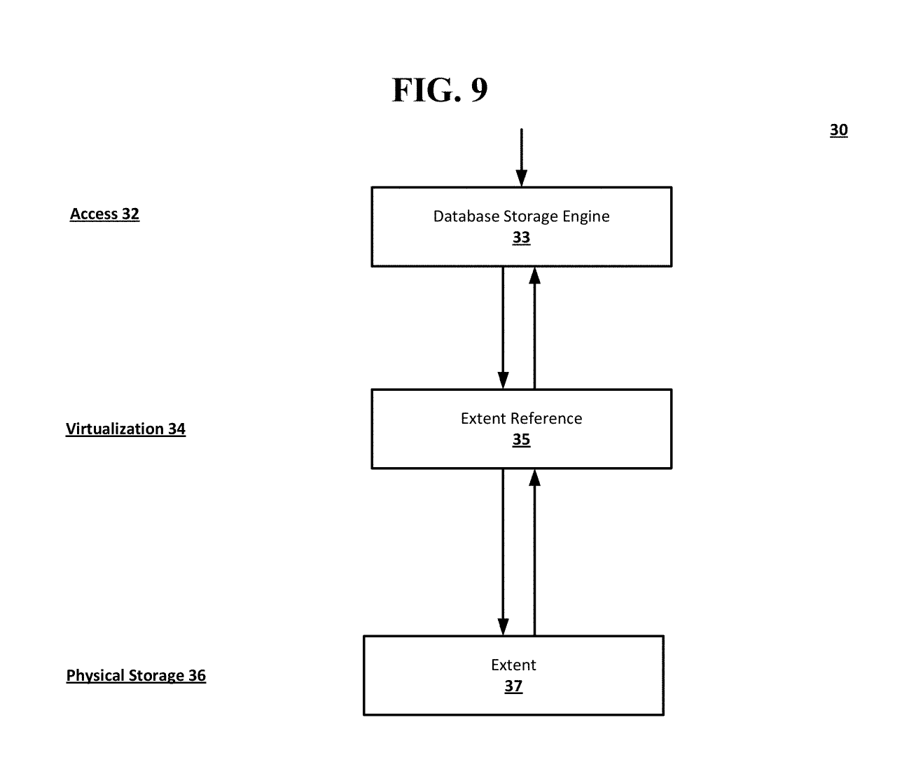

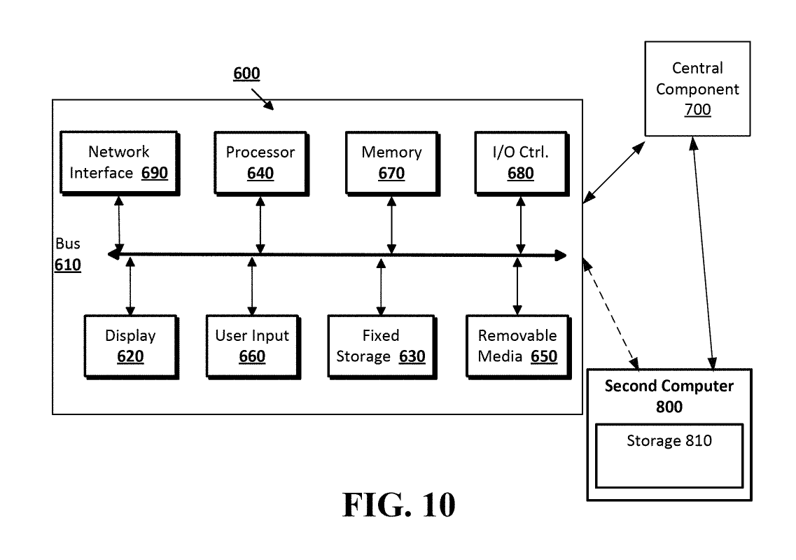

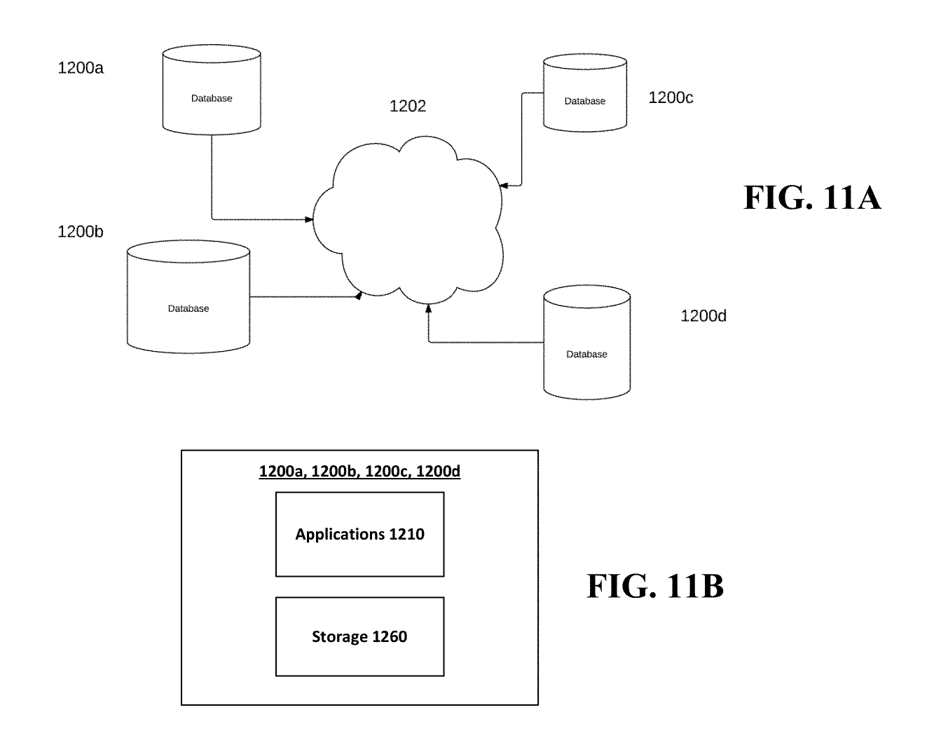

FIG. 1A shows an example method 10 of performing a bounded scan on multi-column keys of a database system according to an implementation of the disclosed subject matter. The method 10 may be used in connection with the systems shown in FIGS. 9-11B, as described in detail below. For example, tenant data may be stored and retrieved from a table in a database system using a virtualization layer 34 and a physical storage 36 shown in FIG. 9. A tenant may have tenant data stored in an immutable storage associated with a tenant identifier, such as storage 810 of second computer 800 shown in FIG. 10, database systems 1200a-d of FIGS. 11A-11B, and the like. For example, a database 1200a may include a one or more physical servers and/or virtual servers may include applications 1210 and storage 1260. The storage 1260 may be a shared storage system. In some implementations, one or more nodes may point to the same data extents though different references.

The tenant data (e.g., stored in the storage 1260 in FIG. 11B) of the table may be associated with a metadata tenant identifier and metadata that is indicative of when records are created and deleted from the database system. There may be different versions of tenant data that are committed to the database system from time-to-time.

In operation 11 of FIG. 1A, the database system, such as database systems 1200a-d of FIGS. 11A-11B, may create an index on one or more columns of a table of a database stored in the storage device. For example, the storage device may be storage 810 of second computer 800 shown in FIG. 10, and/or the storage 1260 shown in FIG. 11B. At operation 12, a first query may be received by, for example, central component 700 shown in FIG. 10, second computer 800 shown in FIG. 10, and/or the database systems 1200a-d shown in FIG. 11A, for data in the indexed table, where the query includes a scan range operation. A column value ordering of the indexed table may be application dependent. That is, the creation of an index of the one or more columns of the table at operation 11 may depend upon the implementation of the database and the number of columns.

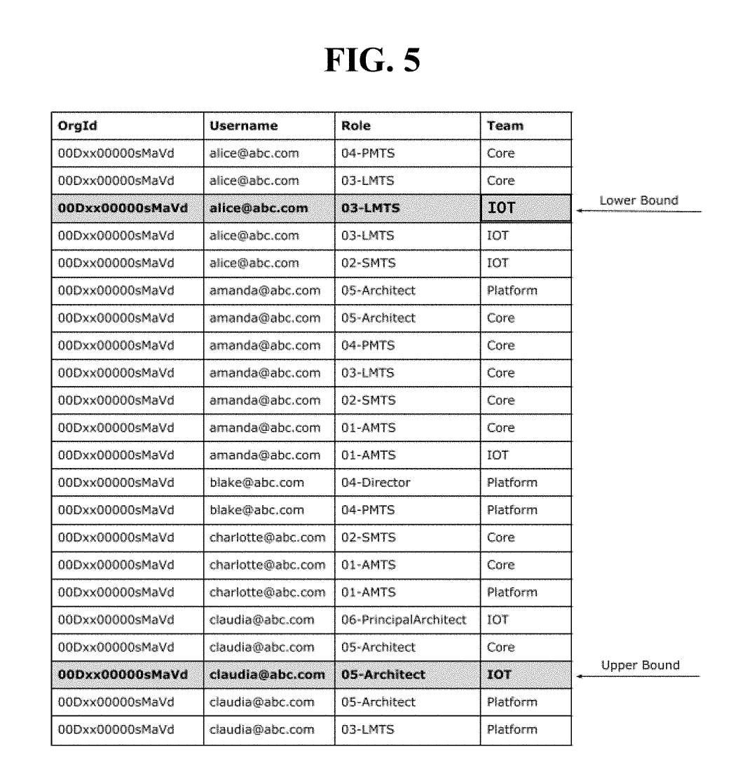

In operation 12, the scan range operation of the received first query for data in the indexed table may include at least one of a full scan of the indexed table, a partial scan of the indexed data, or the like. The first query may be from, for example, computer 600 or central component 700 shown in FIG. 10 by system 30 shown in FIG. 9, second computer 800 shown in FIG. 10, and/or databases 1200a, 1200b, 1200c, and/or 1200d shown in FIGS. 11A-11B. The scan range operation of the received first query for data in the indexed table may be based on an application (e.g., that may be stored and/or executed from application 1210 of databases 1200a, 1200b, 1200c, and/or 1200d shown in FIGS. 11A-11B) that provides the query to the database system. In some implementations, the lower bound and/or the upper bound may be an inclusive bound and/or an exclusive bound, as described in connection with Table 1 and FIGS. 5-8.

At operation 14, central component 700 shown in FIG. 10, system 30 shown in FIG. 9, second computer 800 shown in FIG. 10, and/or the database systems 1200a-d shown in FIG. 11A may translate the first query that includes the scan range operation into a plurality of sub-queries having respective scan ranges. The translating of the first query into the plurality of sub-queries having scan ranges may reduce the complexity of the first query. Table 2, shown and described below, illustrates an example of a range query using the SCAN operator of the disclosed subject matter in comparison to using standard query operators. That is, the first query may include a SCAN RANGE operator (as described below), which may be translated to standard database operators.

At operation 16 of FIG. 1A, the central component 700 shown in FIG. 10, second computer 800 shown in FIG. 10, and/or the database systems 1200a-d may form a second query by combining the sub-queries with an operation. In some implementations, the sub-queries may be combined with a union all operation. The formed second query may be processed by the central component 700 shown in FIG. 10, second computer 800 shown in FIG. 10, and/or the database systems 1200a, and a result of the second query may be output at operation 18. The second query that is output may be used by the central component 700 shown in FIG. 10, second computer 800 shown in FIG. 10, and/or the database systems 1200a-d to perform a scan operation of the table (e.g., a partial scan, a scan of a particular range, a full table scan, or the like).

In some implementations, the scan range may have a lower bound and an upper bound, and the method 10 may include returning zero rows, or one or more rows with column values between the lower bound and the upper bound. In some implementations, the method 10 may return no rows when column values of the upper bound are before the lower bound values. One or more rows may be returned from the beginning of the index in some implementations when column values of the lower bound are null. In some implementations, when column values of the upper bound are null, the method 10 may return zero rows or one or more rows until the end of the index are returned.

The method 10 described above and in implementations disclosed throughout may be performed on a table in a database having records. A record may be identified by a key-value pair in the instance of a multitenant system. In the implementations discussed throughout, the databases may not have notions of tenancy. Tenancy in the databases may be created by one or more virtual overlays, so that a user may view, access, and/or perform operations for a tenancy associated with an authorized user of a database system. The value may be, for example, the contents of a row of a table of a relational database, an identification of a row in a table of a relational database, or any other suitable value. The key may be an identifier for the record, and may in any suitable form, such as, for example, an alphanumeric sequence. Portions of the key may provide information about the contents of the record. For example, a portion of the key may be a tenant identifier, which may uniquely identify the tenant to whom the contents of the record belongs. Other portions of the key may identify, for example, a table number and identification of a row, for example, when the value of a record is the contents of a row, or table number, index number on the table, and an identification of indexed columns when the value is the identification of a row.

The database system (e.g., system 30 shown in FIG. 9, second computer 800 shown in FIG. 10, or databases 1200a, 1200b, 1200c, and/or 1200d shown in FIGS. 11A-11B) may store transactions as immutable versions of given records. Immutable versions of contents of records already stored on the server system may be unchanged until the contents are deleted (if ever) from the server system. That is, a received transaction may create a new version of the contents of the record to be stored in the server system, instead of altering the contents of the record. Thus, it may be possible for multiple versions of a record (e.g., records having different contents) as disclosed herein to have identical keys except for transaction identifiers. The use of otherwise identical keys for versions of a given record may allow for the changing of data stored in the relational database. As such, each version of the physical record may be immutable; i.e., it is either not deleted or is not deleted over an arbitrarily long period of time that may be months, years or decades. For example, a later version of a record with an identical key (other than the transaction version identifier) to an earlier version of the record may indicate a change in the data value for that record (i.e., the change in contents of the record). Alternatively, a transaction may create a record or delete a record (i.e., create contents or delete contents). Records may be deleted by inserting a ‘tombstone’ (e.g., a marker identifying the data to be deleted), and, at a future point in time, a new extent can be written which no longer includes the record marked by the tombstone.

Time stamps or other time identifiers may be made at the creation of a tenant. Thereafter, tenant data may interpret primary key requests for versions of the data before the time stamp by accessing the appropriate version based on the key in the pool of the data stored before the time stamp. Keys for the respective tenants accessing data created or updated after the time stamp will be interpreted to access the appropriate data created by the tenant. Alternatively, rather than using time stamps, each transaction in the database may have a unique transaction number associated with it that is monotonically increasing for each subsequent transaction and the system may note the most recently created transaction identifier in lieu of the time stamp.

FIG. 1B shows an example record used in a database system table (e.g., system 30 shown in FIG. 9, central component 700 and/or second computer 800 shown in FIG. 10, and/or database systems 1200a-1200d shown in FIGS. 11A-11B) according to an implementation of the disclosed subject matter. Records can be keyed by a keyspace (ks), a tenant identifier, an object identifier (objectId), and/or an object key (objectKey). As shown in FIG. 1B, the record may include the tenant identifier, the objectId, and the objectKey. The key of the record may include the tenant identifier, the objectId, and the objectKey. In implementations of the disclosed subject matter, the keys and/or the values may be variable in length. Data extents in implementations of the disclosed subject matter may be sorted by key, and organized by levels in a LSM tree according to a commit time. The database system as disclosed herein may have an immutable storage, which may be used in relational database that stores persistent contents of records, a single key space rooted by a tenant identifier, and by using persistence virtualization. The persistence may be made up of extents. An extent is a typically contiguous region of storage which may be used to store data. As discussed above, extents may be immutable and may be ordered by key.

An extent reference may include an extent identifier, a minimum key, a maximum key, an original tenant identifier, a new tenant identifier, and a filter. An extent reference may include an extent identifier (ExtentId), which may be the physical extent to which this points. A minimum key of an extent reference may be minimum key value that the extent reference can access. The minimum key may be the minimum key in the extent. The maximum key of an extent reference may be the maximum key value that the extent reference can access. The filter may be the maximum value of a commit timestamp that indicates when the record came into existence that the extent reference can ‘see’ in this extent.

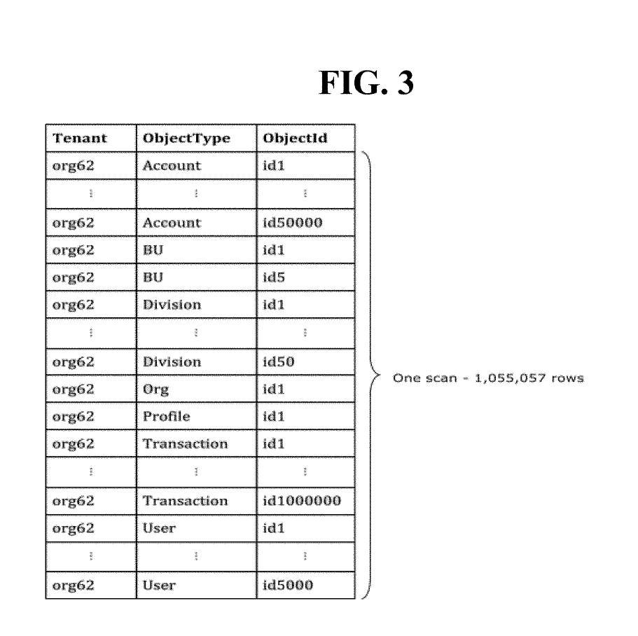

An extent reference may be used as a logical reference to a physical extent that is stored in physical storage (e.g., a storage device), and the extent references may virtualize access to the immutable storage. For example, as shown in FIG. 9, extent references may be part of a virtualization layer 34, which points to an extent 37 in a physical storage 36. At least a portion of the extent references may be grouped into an extent reference set (e.g., that is part of the virtualization layer 34) that points to a persistence associated with a database instance of the database system (e.g., an extent 37 in the physical storage 36 as shown in FIG. 3). Each extent reference of the extent reference set may include a minimum key and a maximum key to set a boundary range for the tenant data that is to be scanned in a scan operation.

Certain types of applications (e.g., one or more applications that may be stored and/or executed from applications 1210) may need to create database tables with multi-column keys. Some examples of such applications are multi-tenant data management applications that have tables with two columns for primary keys, one column for a tenant identifier and one column for a row identifier. Metadata based platforms that provide a mechanism to customize objects or create new objects have two columns for primary keys, one column for an object type identifier and one column for an object identifier.

During the typical operations of these applications, all but one of the columns have constant values. In general, the set of columns that have constant values is the tenant identifier. For example, in a multi-tenant application, all operations will happen in the context of a tenant, and will have a tenant identifier predicate. In metadata based platforms, all operations will happen in the context of an object type, and will have an object type identifier predicate. In this example, the object type identifier is the tenant identifier.

The system and methods of the disclosed subject matter, such as method 10 described above in connection with FIG. 1A, address the undesirable limitations of current database systems. For example, system background jobs may need to scan an entire table in order to operate efficiently. Such a scan requires increased use of database systems resources, and may increase the time to complete the operation. Tools for replication, migration, deletion, sweepers, or the like may also need to scan the entire table in order to operate efficiently.

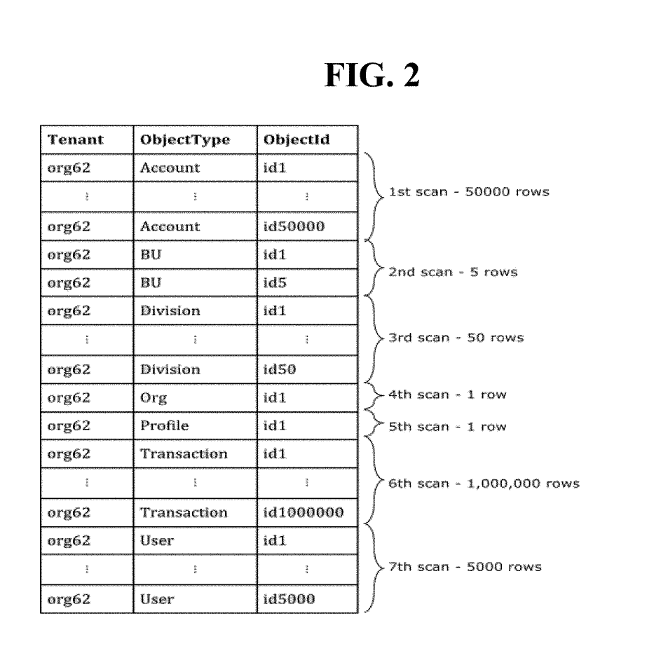

In another example, scanning the table one tenant identifier at a time may require performing a large number of queries with unpredictable size of results. FIG. 2 shows an example of performing scans of a table, one identifier at a time, according to queries in traditional database systems. As shown in FIG. 2, a number of queries are performed, which scan different numbers of rows: the first scan for a query may scan 50,000 rows; a second scan for a query may scan 5 rows; a third scan for a query may scan 50 rows; a fourth scan and a fifth scan for queries may each scan 1 row; a sixth scan for a query may scan 1,000,000 rows; and a seventh scan for a query may scan 5000 rows. That is, in the example shown in FIG. 2, seven different scans are performed for queries to a table in a database, with the number of rows being scanned varying in size in an unpredictable manner. Moreover, in certain cases, it may not be possible to know which tenant identifiers need to be scanned.

Alternatively, full table scans can be performed. FIG. 3 shows an example of performing a traditional full table scan of a database. As shown in FIG. 3, a single scan of the table scans 1,055,057 rows. However, such single, full table scans as shown in FIG. 3 may take a long time and may use a lot of database system resources, thus making such scans infeasible for large tables.

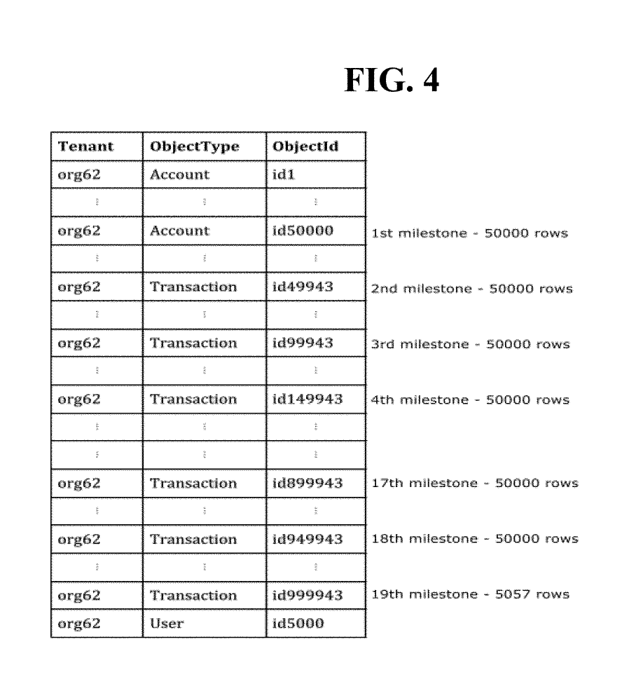

To address the problems shown in FIGS. 2-3 and described above, a database table may be divided into milestones. For example, milestones may be created by scanning the table using an index and identifying the next fixed unit(s) of data. The milestones may be generated incrementally, and can be used as a logical cursor to read the rows of the table. For example, FIG. 4 shows a database table having 1,055,057 rows (as also shown in FIG. 3) that has been divided into milestones with each milestone having 50,000 rows, except for the last milestone, which has the remaining 5057 rows (with the other milestones dividing the 1,000,000 rows into 50,000 row segments).

Systems and methods of the disclosed subject matter may create sorted multi-column indexes on tables. These indexes may be used to improve performance of queries on the tables. System and methods of the disclosed subject matter may also provide an operator (e.g., SCAN RANGE, as discussed throughout) to perform bounded multi-column scans of keys.

Indexes of a database may be built on one or more columns of the table. Each column in the index may be ordered, and the sort order is specified when the index is created. The index may maintained by operations (e.g., insert, update, delete, and the like) on the table.

When performing operations in response to a query on the table, the index may be used to improve performance of the database system (e.g., to more efficiently retrieve information related to the query). Indexes, and the systems and methods disclosed herein, may increase the efficiency row lookup operations (e.g., a unique scan), and may perform scans (e.g., single column scans, a scan of a particular range, or the like).

The systems and methods disclosed herein (e.g., method 10 described above in shown in FIG. 1A) provide an enhancement to query language (e.g., for databases this may be SQL, but it applies to other query languages such for other data systems) by providing an operator (e.g., a SCAN RANGE operator as described below) that allows for data to be accessed using an index.

The following is an example syntax for the SCAN RANGE operator which allows for data to be accessed using an index:

SCAN (sort_specification_list) RANGE [INCLUSIVE/EXCLUSIVE]
(lower_bound_column_values) TO [INCLUSIVE/EXCLUSIVE]
(upper_bound_column_values

Table 1 below describes the elements of the example syntax:

TABLE 1

| | |
|---|---|
| SCAN ... RANGE ... TO ... | These are required keywords unique to |
| | the operator. |
| sort_specification_list: | This is a list of columns in the table. |
| column_name | The order of each column may be |
| [column_order | specified. This is optional. If not |
| [null_order]], | specified, the default may be to use |
| [column_name | an ascending order. This may include |
| [column_order | the ordering for NULL values. Default |
| [null_order]], | NULL ordering may be implementation |
| ...] | dependent. |
| lower_bound_column_values | The lower bound values of the columns |
| | in column_list. The data types and |
| | number of columns in lower_bound_ |
| | columns_values need to match up with |
| | those in column_list. If NULL, it |
| | implies open ended lower bound. |
| upper_bound_columns_values | The upper bound values of the columns |
| | in column_list. The data types and |
| | number of columns in upper_bound_ |
| | columns_values need to match up with |
| | those in column_list. If NULL, it |
| | implies open ended upper bound. |
| INCLUSIVE | This indicates that the bound is |
| | inclusive. This is optional. If not |
| | specified, the default is to use |
| | INCLUSIVE. |
| EXCLUSIVE | This indicates that the bound is |
| | exclusive. This may be optional. If |
| | not specified, the default is to use |
| | INCLUSIVE. |

As described in detail above in connection with FIG. 1A and method 10, and using the syntax described above, a scan operation may return all of the rows with column values between a lower bound and an upper bound. If the upper bound column values are before the lower bound values, then no rows are returned. If the lower bound column values are NULL, all rows from the beginning (unbounded) of the index are returned. If the upper bound column values are NULL, all rows until the end (unbounded) of the index are returned.

The following example may show the creation of a table and an index for the table using the systems (e.g., system 30 shown in FIG. 9, central component 700 and/or second computer 800 shown in FIG. 10, and/or database systems 1200a-1200d shown in FIGS. 11A-11B) and methods (e.g., such as in method 10 described above in connection with FIG. 1A) disclosed herein. The following syntax may be used to create a table:

CREATE TABLE User (
OrgId VARCHAR2(15) NOT NULL,
Username VARCHAR2(50) NOT NULL, Role NUMBER NOT NULL,
Team VARCHAR2(50) NOT NULL,
StartDate DATE NOT NULL, EndDate DATE
);

The following example may show the creation of an index for the table:

CREATE UNIQUE INDEX UniqueUserRoleTeam ON User (
OrgId ASC,
Username ASC,
Role DESC,
Team ASC
);

The syntax above may create a table for a particular user, where the table has entries for OrgID, Username, Team, StartDate, and Enddate. The indexing indicated that the OrgID, Username, and Team have indices that ascend (i.e., “ASC”), and that Role has indices that descend (i.e., “DESC”).

FIG. 5 shows an example of the table created and indexed using the syntax above, which has been divided using a lower bound and an upper bound according to an implementation of the disclosed subject matter. As shown in FIG. 5, the lower bound may be set at the entry having OrgID of 00Dxx00000sMaVd, Username of alice@abc.com, Role of 03-LMTS, and Team of Platform. The upper bound may be set at the entry having OrgID of 00Dxx00000sMaVd, Username of claudia@abc.com, Role of 05-Architect, and Team of IOT.

With the created table, a query to select rows between the lower bound and upper bound as inclusive may have the following syntax:

SELECT u.OrgId, u.Username, u.Role, u.Team, u.StartDate,
u.EndDate FROM User u
WHERE u.OrgId = ‘00Dxx00000sMaVd’
AND SCAN (u.Username ASC, u.Role DESC, u.Team ASC) RANGE
INCLUSIVE(‘alice@abc.com’, ‘03-LMTS’, ‘IOT’) TO
INCLUSIVE(‘claudia@abc.com’, ‘05-Architect’, ‘IOT’);

The syntax example above sets an inclusive scan range from the lower bound entry having a Username of alice@abc.com, a Role of 03-LMTS, and a Team of IOT to the upper bound entry of a Username of claudia@abc.com, a Role of 05-Architect, and a Team of IOT.

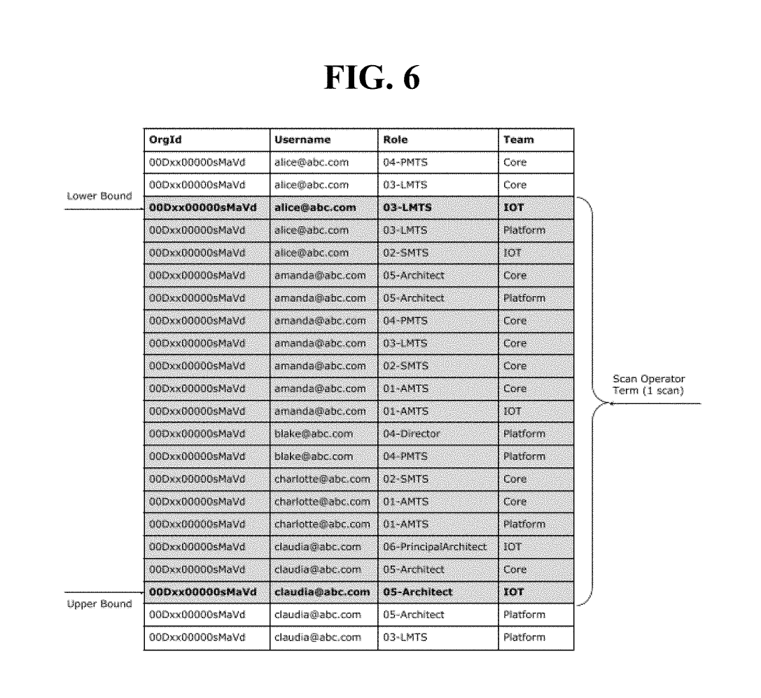

FIG. 6 shows an example of scanning an index starting at lower bound column values and ending at upper bound column values, and returning the resulting rows in the range according to an implementation of the disclosed subject matter. When used in a query, the database system (e.g., system 30 shown in FIG. 9, central component 700 and/or second computer 800 shown in FIG. 10, and/or database systems 1200a-1200d shown in FIGS. 11A-11B) may scan the index once, as shown in FIG. 6, starting at the lower bound column values and ending at the upper bound column values. The database system may return the resulting rows in that range. That is, as shown in FIG. 6, the scan operator term returns the resulting rows in the range from the lower bound to the upper bound, in one scan. Implementations of the disclosed subject matter break the query into multiple smaller respective index scans. In some implementations, the smaller index scans may be connected by a UNION ALL set operation, or by any other suitable connection operation.

Systems and methods of the disclosed subject matter may translate SCAN RANGE queries into standard database queries (e.g., SQL queries or the like) while minimizing efficiency loss. In some implementations, the resulting query may be composed of sub-queries joined by a UNION ALL operation or by any other suitable connection operation.

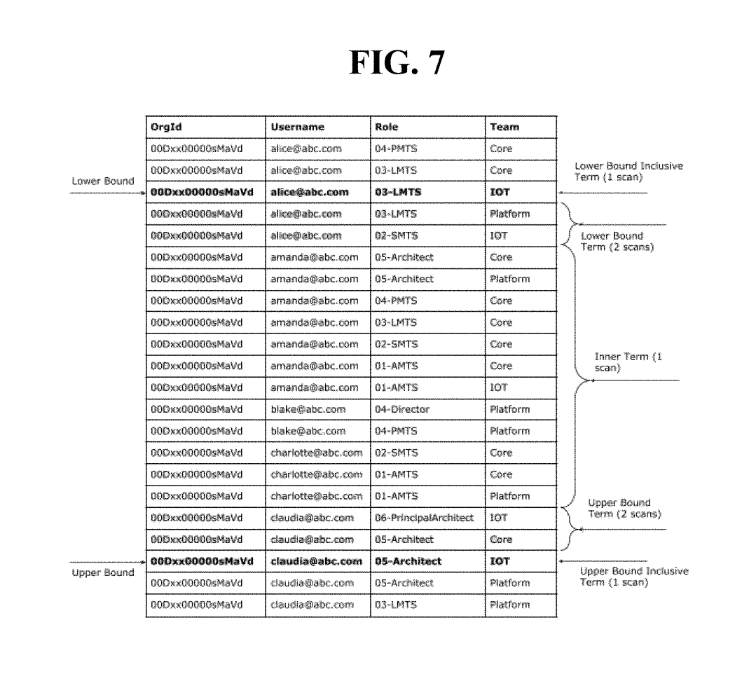

As an example, the following syntax may set a lower bound inclusive term, and may select up to one row. This may be used, for example, only when lower bound is not NULL and is INCLUSIVE. The lower bound inclusive term is shown in FIG. 7.

EQUALS(col_name[1], lower_bound_value[1])
AND EQUALS(col_name[2], lower_bound_value[2])
...
AND EQUALS(col_name[N], lower_bound_value[N])

A lower bound term may include the following sub-queries joined by a UNION ALL operation or other suitable operation. This may be used, for example, only when the lower bound is not NULL. The lower bound term is shown in FIG. 7.

a. N-th term sub-query:

EQUALS(col_name[1], lower_bound_value[1])
AND EQUALS(col_name[2], lower_bound_value[2])
...
AND AFTER(col_name[N],
lower_bound_value[N])

b. N−1 th term sub-query:

EQUALS(col_name[1], lower_bound_value[1])
AND EQUALS(col_name[2], lower_bound_value[2])
...
AND AFTER(col_name[N-1], lower_bound_value[N-1])

d. 2nd term sub-query:

EQUALS(col_name[1], lower_bound_value[1])
AND AFTER(col_name[2], lower_bound_value[2])

An inner term query may be illustrated in the below example query. The inner term query is shown in FIG. 7.

AFTER(col_name[1], lower_bound_value[1])

AND BEFORE(col_name[1], lower_bound_value[1])

An upper bound term may include the following sub-queries joined by a UNION ALL operation. This may be used, for example, only when the upper bound is not NULL. The upper bound term is shown in FIG. 7.

a. 2nd term sub-query:

EQUALS(ol_name[1], lower_bound_value[1])
AND BEFORE(col_name[2], lower_bound_value[2])

b. N−1 th term sub-query:

EQUALS(ol_name[1], lower_bound_value[1])
AND EQUALS(col_name[2], lower_bound_value[2])
...
AND BEFORE(col_name[N-1], lower_bound_value[N-1])

c.

d. N-th term sub-query:

EQUALS(ol_name[1], lower_bound_value[1])
AND EQUALS(col_name[2], lower_bound_value[2])
...
AND BEFORE(col_name[N], lower_bound_value[N])

An upper bound inclusive term may select up to one row, as shown in the example query below. This may be used, for example, only when the upper bound is not NULL and inclusive. The upper bound inclusive term is shown in FIG. 7.

col_name [1]=upper_bound_value [1]

AND_col_name[2]=upper_bound_value [2] AND . . .

AND_col_name [N]=upper_bound_value [N]

The queries above may have the following conditions:

EQUALS (col, value): col is equal to value

AFTER (col, value): col is after value in sort_specification_list order

BEFORE (col, value): col is before value in sort_specification_list order

Table 2 below shows an example comparison of the queries on a database table with a three column scan that selects the same set of rows. In the first column, “Using SCAN operator,” the query may use the SCAN RANGE operator of the disclosed subject matter. In the second column, “Using Standard Operator,” the query may use standard database operators (e.g., standard SQL operators or the like). The complexity of the query using standard operators is significantly more than that using the SCAN RANGE operator with the systems and methods disclosed herein. The complexity of the query may increase proportionally to the number of scan columns.

TABLE 2

| Using SCAN operator | Using Standard operator |
|---|---|
| /* selects 18 rows */ | /* lower bound inclusive term, select 1 row |
| SELECT /*+ INDEX(u UniqueUserRoleTeam) */ | */ SELECT /*+ INDEX(u |
| u.OrgId, u.Username, u.Role, u.Team, | UniqueUserRoleTeam) */ u.OrgId, |
| u.StartDate, u.EndDate | u.Username, u.Role, u.Team, |
| FROM User u | u.StartDate, u.EndDate |
| WHERE u.OrgId = ‘00Dxx00000sMaVd’ | FROM User u |
| AND SCAN (u.Username ASC, u.Role DESC, | WHERE u.OrgId = |
| u.Tea ASC) RANGE | ‘00Dxx00000sMaVd’ AND |
| INCLUSIVE(‘alice@abc.com’, ‘03-LMTS’, | u.Username = ‘alice@abc.com’ |
| ‘IOT’) TO | AND u.Role = ‘03-LMTS’ |
| INCLUSIVE(‘claudia@abc.com’, | AND u.Team = |
| ‘05-Architect’, ‘IOT’); | ‘IOT’ UNION ALL |
| | /* lower bound term, selects 2 rows */ |
| | SELECT /*+ INDEX(u UniqueUserRoleTeam) |
| | */ u.OrgId, u.Username, u.Role, u.Team, |
| | u.StartDate, u.EndDate |
| | FROM User u |
| | WHERE u.OrgId = |
| | ‘00Dxx00000sMaVd’ AND |
| | u.Username = ‘alice@abc.com’ |
| | AND u.Role = ‘03-LMTS’ |
| | AND u.Team > |
| | ‘IOT’ UNION ALL |
| | SELECT /*+ INDEX(u UniqueUserRoleTeam) |
| | */ u.OrgId, u.Username, u.Role, u.Team, |
| | u.StartDate, u.EndDate |
| | FROM User u |
| | WHERE u.OrgId = |
| | ‘00Dxx00000sMaVd’ AND |
| | u.Username = ‘alice@abc.com’ |
| | AND u.Role < ‘03-LMTS’ |
| | UNION ALL |
| | /* inner term, selects 12 rows */ |
| | SELECT /*+ INDEX(u UniqueUserRoleTeam) |
| | */ u.OrgId, u.Username, u.Role, u.Team, |
| | u.StartDate, u.EndDate |
| | FROM User u |
| | WHERE u.OrgId = |
| | ‘00Dxx00000sMaVd’ AND u.Username |
| | > ‘alice@abc.com’ AND u.Username |
| | < ‘claudia@abc.com’ UNION ALL |
| | /* upper bound term, selects 2 rows */ |
| | SELECT /*+ INDEX(u UniqueUserRoleTeam) |
| | */ u.OrgId, u.Username, u.Role, u.Team, |
| | u.StartDate, u.EndDate |
| | FROM User u |
| | WHERE u.OrgId = |
| | ‘00Dxx00000sMaVd’ AND u.Username |
| | = ‘claudia@abc.com’ AND u.Role > |
| | ‘05-Architect’ |
| | UNION ALL |

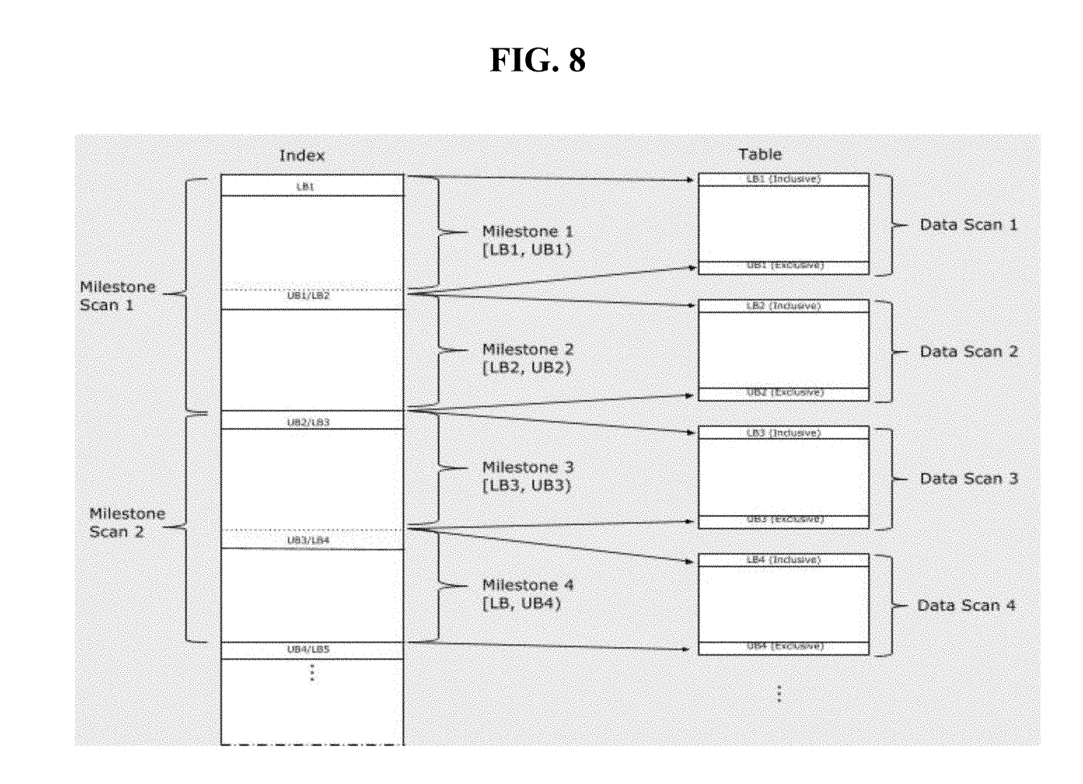

The systems and methods disclosed herein may be used for an audit feature, where a user may need to walk through all the data. In some implementations, the data may be stored in one database table with a two column index (e.g., BusinessObjectType and BusniessObjectld). Using the above-described methods, a scan may be performed of the index using the SCAN RANGE operator to create milestones. Using these milestones as the LOWER BOUND and UPPER BOUND for the SCAN RANGE operator, the table may be scanned to process the rows, as shown in FIG. 8. A MILESTONE SCAN may be performed on the index using the SCAN RANGE operator with no upper bound to generate milestones. A DATA SCAN may perform one or more operations on the table data using the SCAN RANGE operator with upper and lower bounds from the milestones created by the MILESTONE SCAN.

FIG. 9 shows an example system for retrieving (i.e., accessing records in response to a query), performing a scan of a portion of the database (e.g., a full table scan, a scan of a particular range, or the like), inserting, and/or updating records according to an implementation of the disclosed subject matter. The system 30 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. For simplicity, components such as the processor, short and long term storage, the operating system, much of the database management system are not shown. The server system 30 may be part of a computing system and network infrastructure, or may be otherwise connected to the computing system and network infrastructure, including a larger server network which may include other server systems similar to the server system 30. In some implementations, the system 30 may be the computer 600, central component 700, and or the second computer 800 shown in FIG. 10, and/or one or more of the database systems 1200a-1200d shown in FIGS. 11A-11B.

An access layer 32 of the system 30 may have a database storage engine 33, which may receive or complete a query and/or instruction for the database system (e.g., central component 700 shown in FIG. 10 and/or database systems 1200a-1200d shown in FIG. 11A-11B) from a computing device (e.g., computer 600 and/or a second computer 800 shown in FIG. 10) regarding data. The query may be for particular data from a tenant, a full scan of the table and/or a scan range, and/or may be an instruction to insert and/or update data of a tenant. The database storage engine 33 may be any suitable combination of hardware and software on the server system 30 for receiving queries for the database system, retrieving data related to the received query and/or instruction, and/or performing a scan of the table of the database system.

The system 30 may include a virtualization layer 34, which may have an extent reference 35. In some implementations, the extent reference 35 may be part of the central component 700 shown in FIG. 10 and/or database systems 1200a-1200d shown in FIGS. 11A-11B. The extent reference 35 may be any suitable combination of hardware and software on the system 30 to perform as the virtualization layer 34 between the database storage engine 33 and physical storage 36 (e.g., where extents may be stored as part of extent 37, as described below). The physical storage 36 may be semiconductor memory, a solid-state drive (SSD), hard disk drive, optical memory, an optical storage device, or any other suitable physical data storage medium, or some combination thereof.

Implementations of the presently disclosed subject matter may be implemented in and used with a variety of component and network architectures. FIG. 10 is an example computer 600 suitable for implementing implementations of the presently disclosed subject matter. As discussed in further detail herein, the computer 600 may be a single computer in a network of multiple computers. As shown in FIG. 10, the computer 600 may communicate with a central or distributed component 700 (e.g., server, cloud server, database, cluster, application server, etc.). The central component 700 may communicate with one or more other computers such as the second computer 800, which may include a storage device 810. The second computer 800 may be a server, cloud server, or the like. The storage 810 may use any suitable combination of any suitable volatile and non-volatile physical storage mediums, including, for example, hard disk drives, solid state drives, optical media, flash memory, tape drives, registers, and random access memory, or the like, or any combination thereof.

Data may be stored in any suitable format in, for example, the storage 810, using any suitable filesystem or storage scheme or hierarchy. For example, the storage 810 may store data using a table and/or a log structured merge (LSM) tree with multiple levels. Further, if the systems shown in FIGS. 9-11B are multitenant systems, the storage may be organized into separate log structured merge trees for each instance of a database for a tenant. That is, there may be separate databases (e.g., LSM trees) for each tenant. Alternatively, contents of all records on a particular server or system may be stored within a single log structured merge tree, in which case unique tenant identifiers associated with versions of records may be used to distinguish between data for each tenant as disclosed herein. More recent transactions may be stored at the highest or top level of the tree and older transactions may be stored at lower levels of the tree.

The information obtained to and/or from a central component 700 may be isolated for each computer such that computer 600 may not share information with computer 800. Alternatively or in addition, computer 600 may communicate directly with the second computer 800.

The computer (e.g., user computer, enterprise computer, etc.) 600 includes a bus 610 which interconnects major components of the computer 600, such as a central processor 640, a memory 670 (typically RAM, but which may also include ROM, flash RAM, or the like), an input/output controller 680, a user display 620, such as a display or touch screen via a display adapter, a user input interface 660, which may include one or more controllers and associated user input or devices such as a keyboard, mouse, WiFi/cellular radios, touchscreen, microphone/speakers and the like, and may be closely coupled to the I/O controller 680, fixed storage 630, such as a hard drive, flash storage, Fibre Channel network, SAN device, SCSI device, and the like, and a removable media component 650 operative to control and receive an optical disk, flash drive, and the like.

The bus 610 enable data communication between the central processor 640 and the memory 670, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 600 can be stored on and accessed via a computer readable medium, such as a hard disk drive (e.g., fixed storage 630), an optical drive, floppy disk, or other storage medium 650.

The fixed storage 630 may be integral with the computer 600 or may be separate and accessed through other interfaces. The fixed storage 630 may be part of a storage area network (SAN). A network interface 690 may provide a direct connection to a remote server via a telephone link, to the Internet via an internet service provider (ISP), or a direct connection to a remote server via a direct network link to the Internet via a POP (point of presence) or other technique. The network interface 690 may provide such connection using wireless techniques, including digital cellular telephone connection, Cellular Digital Packet Data (CDPD) connection, digital satellite data connection or the like. For example, the network interface 690 may enable the computer to communicate with other computers and/or storage devices via one or more local, wide-area, or other networks, as shown in FIG. 5.

Many other devices or components (not shown) may be connected in a similar manner (e.g., data cache systems, application servers, communication network switches, firewall devices, authentication and/or authorization servers, computer and/or network security systems, and the like). Conversely, all of the components shown in FIG. 10 need not be present to practice the present disclosure. The components can be interconnected in different ways from that shown. Code to implement the present disclosure can be stored in computer-readable storage media such as one or more of the memory 670, fixed storage 630, removable media 650, or on a remote storage location.

FIGS. 11A-11B show an example network arrangement according to an implementation of the disclosed subject matter. Four separate database systems 1200a-d at different nodes in the network represented by cloud 1202 communicate with each other through networking links 1204 and with users (not shown). Each of database systems 1200 may be operable to host multiple instances of a database, where each instance is accessible only to a particular tenant (e.g., users associated with a particular tenant who are authorized to access the data of the tenant). Each of the database systems may constitute a cluster of computers along with a storage area network (not shown), load balancers and backup servers along with firewalls, other security systems, and authentication systems. Some of the instances at any of systems 1200 may be live or production instances processing and committing transactions received from users or from computing elements (not shown) for ingesting and providing data for storage in the instances.

One or more of the database systems 1200a-1200d may receive a query and perform a full table scan and/or one or more scan ranges for tenant data in a table. The database systems 1200a-1200d may include at least one storage device, such as storage 1260 shown in FIG. 11B. In some implementations, the storage may include memory 670, fixed storage 630, removable media 650 shown in FIG. 10, a storage device included with the central component 700 and/or storage 810 of the second computer 800 shown in FIG. 10. The storage may include one or more storage devices that provide persistent storage of data (e.g., tenant data).

FIGS. 11A-11B show an individual database system 1200a, 1200b, 1200c, or 1200d according to an implementation of the disclosed subject matter. The database system 1200a, 1200b, 1200c, or 1200d may include one or more applications 1210 (shown in FIG. 11B), which may use data and/or information from the node 1220 and/or the storage 1260, which may be one or more storage devices. Applications 1210 may include customer relationship management (CRM) applications or the like. Storage 1260 may be one or more storage devices, and may store data extents 1270 which may include tenant data.

Tenant data may be stored in an immutable storage (e.g., storage 1260 of FIG. 11B) of the at least one storage device associated with an original tenant identifier. The original tenant data may be used to create a snapshot for a point-in-time restore operation. The one or more servers of the systems shown in FIGS. 9-11B may receive a request to perform a partial scan, a scan of a particular range, and/or a full table scan of tenant data. The key included in the scan request may include a transaction point from which to perform the scan of table data at a point in time, or may reference a time stamp or sequence indicator. The one or more servers of the systems shown in FIGS. 9-11B may receive the data from the immutable storage for the tenant from the at least one storage device (e.g., the storage device associated with central component 700, the storage 810 of the second computer 800, and/or the storage 1260 of the database systems 1200a-1200d) based on the dynamic mapping of the key indicating the data for the tenant in the table.

The one or more servers of the systems shown in FIGS. 9-11B may receive a request (e.g., from computer 600 shown in FIG. 10, or the like) for a scan of at least a portion of a table having tenant data, and may perform at least a partial scan and/or a scan of a particular range on the table for data from the immutable storage of the at least one storage device. The one or more servers receive the data from the immutable storage (e.g., storage 1260 shown in FIGS. 6B-6C) from the at least one storage device for the tenant, and may perform the scan of the table.

The tenant data may be associated with a metadata tenant identifier and metadata that is indicative of when records are created and deleted from the database system, and is indicative of different versions of tenant data that are committed to the database system from time-to-time. At least one server (e.g., computer 600, central component 700, second computer 800, and/or the storage 1260 of the database systems 1200a-1200d) may locate metadata to identify the data of a tenant stored in the storage device.

The system 30 shown in FIG. 9, the central component 700 shown in FIG. 10, the second computer 800 shown in FIG. 10, and/or the database systems 1200a-1200d shown in FIG. 11 A may perform a bounded scan on multi-column keys. A storage device, such as the storage 810 of second computer 800 shown in FIG. 10, and/or the storage 1260 shown in FIG. 11B may store data of a database. A server system, such as the central component 700 shown in FIG. 10, the second computer 800 shown in FIG. 10, and/or the database systems 1200a-1200d may create an index on one or more columns of a table of a database stored in the storage device. The column value ordering of the indexed table may be application dependent.

The server system may receive a first query for data in the indexed table, where the query includes a scan range. The server system may translate the first query that includes the scan range into a plurality of sub-queries having respective scan ranges. That is, the server system may translate the first query into the plurality of sub-queries having respective scan ranges to reduce the complexity of the first query. The scan range may have a lower bound and an upper bound, and the server system may return zero rows or one or more rows with column values between the lower bound and the upper bound. In some implementations, the server system may return no rows when column values of the upper bound are before the lower bound values. In some implementations, the server system may return zero rows, or one or more rows from the beginning of the index when column values of the lower bound are null. In some implementations, the server system may return zero rows, or one or more rows until the end of the index are returned when column values of the upper bound are null.

In some implementations, the scan range of the received first query for data in the indexed table may include a full scan of the indexed table and/or a partial scan of the indexed data. IN some implementations, the scan range of the received first query for data in the indexed table is based on an application that provides the query to the server system. The lower bound and/or the upper bound may be an inclusive bound and/or an exclusive bound.

The server system may form a second query by combining the sub-queries with an operation, process the formed second query, and output a result of the second query. The server system combines the sub-queries by using a union all operation.

The systems and methods of the disclosed subject matter may be for single tenancy and/or multitenancy systems. Multitenancy systems may allow various tenants, which may be, for example, users, groups of users, or organizations, to access their own records on the server system through software tools or instances on the server system that may be shared among the various tenants. The contents of records for each tenant may be part of a database containing that tenant. Contents of records for multiple tenants may all be stored together within the same database system, but each tenant may only be able to access contents of records which belong to, or were created by, that tenant. This may allow a database system to enable multitenancy without having to store each tenants' contents of records separately, for example, on separate servers or server systems. The database for a tenant may be, for example, a relational database, hierarchical database, or any other suitable database type. All records and/or tables stored on the server system may be stored in any suitable structure, including, for example, a LSM tree.

A multitenant system may have various tenant instances on server systems distributed throughout a network with a computing system at each node. The live or production database instance of each tenant may only have its transactions processed at one computer system. The computing system for processing the transactions of that instance may also process transactions of other instances for other tenants. The computing system may store at least one table of a database that includes tenant data.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computerized method for performing a bounded scan on multi-column keys of a database system which stores data in a storage device, the method comprising:
creating, at the database system, an index on one or more columns of a table of a database stored in the storage device;
receiving, at the database system, a first query for data in the indexed table, wherein the query includes a scan range operation;
translating, at the database system, the first query that includes the scan range operation into a plurality of sub-queries having respective scan ranges;
forming, at the database system, a second query by combining the sub-queries with an operation; and
processing, at the database system, the formed second query and outputting a result of the second query.

2. The method of claim 1, wherein the combining the sub-queries are combined with a union all operation.

3. The method of claim 1, wherein the translating the first query into the plurality of sub-queries having respective scan ranges to reduce the complexity of the first query.

4. The method of claim 1, wherein the scan range operation has a lower bound and an upper bound, the method further comprising:
returning zero rows, or one or more rows with column values between the lower bound and the upper bound.

5. The method of claim 1, wherein the scan range operation has a lower bound and an upper bound, the method further comprising:
returning no rows when column values of the upper bound are before the lower bound values.

6. The method of claim 1, wherein the scan range operation has a lower bound and an upper bound, the method further comprising:
when column values of the lower bound are null, returning zero rows or one or more rows from the beginning of the index are returned.

7. The method of claim 1, wherein the scan range operation has a lower bound and an upper bound, the method further comprising:
when column values of the upper bound are null, returning one or more rows until the end of the index are returned.

8. The method of claim 1, wherein column value ordering of the indexed table is application dependent.

9. The method of claim 1, wherein the scan range operation of the received first query for data in the indexed table includes at least one from the group consisting of: a full scan of the indexed table and a partial scan of the indexed data.

10. The method of claim 9, wherein the scan range operation of the received first query for data in the indexed table is based on an application that provides the query to the database system.

11. The method of claim 9, wherein at least one of the lower bound and the upper bound is selected from the group consisting of: null, an inclusive bound, and an exclusive bound.

12. A system to perform a bounded scan on multi-column keys comprising:
a storage device to store data of a database; and
a server system to:
create an index on one or more columns of a table of a database stored in the storage device;
receive a first query for data in the indexed table, wherein the query includes a scan range operation;
translate the first query that includes the scan range operation into a plurality of sub-queries having respective scan ranges;
form a second query by combining the sub-queries with an operation; and
process the formed second query and output a result of the second query.

13. The system of claim 12, wherein the server system combines the sub-queries by using a union all operation.

14. The system of claim 12, wherein the server system translates the first query into the plurality of sub-queries having respective scan ranges to reduce the complexity of the first query.

15. The system of claim 12, wherein the scan range operation has a lower bound and an upper bound, and
wherein the server system returns zero rows, or one or more rows with column values between the lower bound and the upper bound.

16. The system of claim 12, wherein the scan range operation has a lower bound and an upper bound, the method further comprising:
returning no rows when column values of the upper bound are before the lower bound values.

17. The system of claim 12, wherein the scan range operation has a lower bound and an upper bound, and
wherein the server system returns zero rows, or one or more rows from the beginning of the index when column values of the lower bound are null.

18. The system of claim 12, wherein the scan range operation has a lower bound and an upper bound, and
wherein the server system returns zero rows, or one or more rows until the end of the index are returned when column values of the upper bound are null.

19. The system of claim 12, wherein column value ordering of the indexed table is application dependent.

20. The system of claim 12, wherein the scan range operation of the received first query for data in the indexed table includes at least one from the group consisting of: a full scan of the indexed table and a partial scan of the indexed data.

21. The system of claim 20, wherein the scan range operation of the received first query for data in the indexed table is based on an application that provides the query to the server system.

22. The system of claim 20, wherein at least one of the lower bound and the upper bound is selected from the group consisting of: null, an inclusive bound, and an exclusive bound.
